(19) United States
(12) Patent Application Publication
(10) Pub. No.: US 2006/0134287 A1
(43) Pub. Date: Jun. 22, 2006

(54) Packaging and cooking bag and method for packaging and preparing a meat product

(76) Inventors: Robert James Vimini, Salisbury, MD (US); Douglas L. Czajkowski, Salisbury, MD (US); Philip J. Carcara, Ocean City, NJ (US)

Correspondence Address: RATNERPRESTIA, P.O. BOX 980, VALLEY FORGE, PA, 19482-0980, US

(21) Appl. No.: 10/643,881

(22) Filed: Aug. 20, 2003

(51) Int. Cl. A23B 4/06

(52) U.S. Cl. 426/393

(57) ABSTRACT

In a method for packaging and preparing a meat product, the meat product is placed in the bag, frozen, shipped and then cooked in the bag. The bag is preferably a monolayer bag comprising a polyamide referred to as nylon 66. In highly preferred embodiments, the bag consists essentially of nylon 66 and a heat stabilizer. The bag preferably includes a first sealed end with chamfered corners. The bag is sized such that it fits snugly around the meat product and the second end of the bag is preferably held closed, e.g. with a metal band or clip. The bag remains sealed during cooking. Preferably, a gap of about one inch to about three inches forms between the meat product and the bag during cooking, which promotes browning, prevents messes, and decreases cooking time.

The present invention is related generally to bags suitable for packaging and cooking, and more particularly to packaging/cooking bags for meat products including both poultry and red meat products.

### BACKGROUND OF THE INVENTION

Cooking bags are well known in the food industry and have been used for many years. Cooking bags are used with a wide variety of foods, including meats. Cooking bags are sometimes used only for cooking. These types of bags may be attached to the food product. Alternatively, these cooking bags may be sold separately to consumers. Cooking bags sold under the REYNOLDS® mark are examples of such products.

Other cooking bags are used both to store and cook the food. The assignee of the present invention, Perdue Farms, Inc., has sold meats such as turkey breasts packaged in a polyester-based cooking bag under the CARVING CLASSICS™ mark. These products are directed toward the catering and restaurant industries as well as delicatessens, including delicatessen departments in supermarkets, where these products are often advertised as “store-cooked.” The CARVING CLASSICS™ products, which are preferably marinated, are packaged in the polyester bags, frozen, shipped to the customer and then (optionally thawed and) cooked in the polyester bags at temperatures typically between 300 and 375 degrees Fahrenheit. The bags vent during cooking—that is, the heat seals at one of the end of the bag fail. It is the understanding of the inventors that the seals are intentionally designed to fail so that the bag vents during the cooking process in order to keep the bag in contact with the meat product to prevent moisture from escaping the meat.

Several drawbacks associated with these polyester-based bags have become apparent to the inventors. First, these polyester bags are prone to breaking during manufacturing and handling. This breaking problem is especially bad when the bags are handled while the contents are still frozen; however, the bags also break when handled after the contents have been thawed, both before and after cooking.

A second problem with these bags is that having the bag in contact with the meat during cooking retards browning of the meat. Third, because the bag is in contact with the meat, removing these types of bag often results in the undesirable removal of the skin and/or other meat coatings. Fourth, juices from the meat often escape through the vents formed by the failed heat seals causing the meat to dry and causing a mess which must be cleaned after the cooking is finished. This is an inconvenience and, in a commercial setting, increases the cost associated with the preparation of the meat.

It should also be noted that these bags are typically heated during the packing process. That is, once the meat product has been placed in the bag, the bag is either placed in a heat tunnel and/or bathed or rinsed in hot water to shrink the bag in a manner well known in the art. The bag is shrunk so that it fits tightly over the product in the bag to promote the appearance of the product. In the case of turkey breast products, shrinking the bag helps keeps the lobes of the breast together. This heat shrink process typically requires temperatures of approximately 190 degrees Fahrenheit. Subjecting the bag to such high temperatures makes it more difficult for factory workers to handle the bags, often requiring them to wear gloves. Of course, any high temperature heating process, whether it be a heat tunnel or hot water bath/rinse, requires energy and therefore increases cost.

Alternatives to the above-mentioned polyester bags are known in the industry. One type of alternative bag known to the inventors is a bag made from nylon materials. Examples of such alternative bags and materials for making such alternative bags are discussed in U.S. Pat. Nos. 4,734,327, 4,758,463, 4,855,183, 6,346,285, 6,203,750, 6,436,495, 5,759,648, 5,053,259, 5,328,470, 5,344,679, 5,759,648, 4,997,710, 4,857,408, 4,857,399, 5,480,945 and 6,329,465. Many of the bags discussed therein suffer from one or more of the following disadvantages: (i) they are multilayer bags, which increases costs associated with manufacturing such bags; (ii) the bags have one or more layers formed by blending materials, which again increases cost; and/or (iii) the bags include heat shrink material, which requires high temperature heat tunnel and/or hot water bath/rinse processing, thereby implicating the disadvantages discussed above.

### SUMMARY

The present invention addresses the aforementioned issues to a great extent by providing a bag and a method for packaging and preparing a meat product in which the meat product (which may be skinless or include skin and which is preferably marinated) is placed in the bag, frozen, shipped and then cooked in the bag. The bag is preferably a monolayer bag comprising a polyamide referred to as nylon 66. The bag preferably comprises at least 50% nylon 66 by weight, more preferably at least 90% nylon 66 by weight, and more preferably still at least 98% nylon 66 by weight. In highly preferred embodiments, nylon 66 is the sole polymer component of the bag. Even more preferably, the bag consists essentially of nylon 66 and a heat stabilizer. The bag preferably includes a first sealed end with chamfered corners. The bag is sized such that it fits snugly around the meat product and the second end of the bag is preferably held closed, e.g. wire plastic tie or with a metal band or clip. The meat product is optionally thawed and then cooked while still inside the bag. The bag remains sealed during cooking. Preferably, a gap of about one inch to about two inches forms between the meat product and the bag during cooking, which promotes browning, prevents messes, and decreases cooking time.

### BRIEF DESCRIPTION OF THE DRAWINGS

A more complete appreciation of the invention and many of the attendant features and advantages thereof will be readily obtained as the same become better understood by reference to the following detailed description when considered in connection with the accompanying drawings, wherein:

FIG. 1 is a diagram of a cooking bag according to the present invention.

FIG. 2 is a diagram of the cooking bag of FIG. 1 after a meat product has been placed inside of the bag.

FIGS. 3a and 3b are cross sectional diagrams of the cooking bag of FIG. 2 prior to and during cooking, respectively.

### DETAILED DESCRIPTION

The present invention will be discussed with reference to preferred embodiments of cooking bags. Specific details are set forth in order to provide a thorough understanding of the present invention. The preferred embodiments discussed herein should not be understood to limit the invention. Furthermore, for ease of understanding, certain method steps are delineated as separate steps; however, these steps should not be construed as necessarily distinct nor order dependent in their performance.

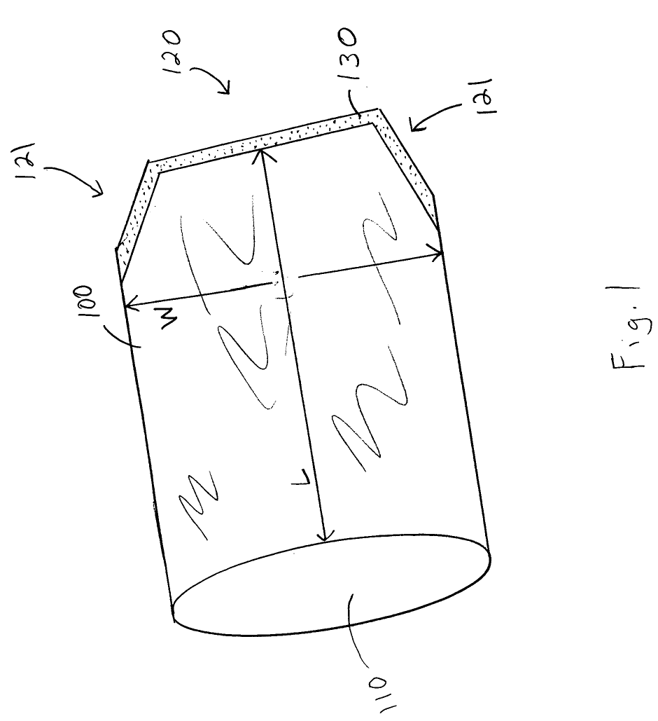

Referring now to the drawings, wherein like reference numerals designate identical or corresponding parts throughout the several views, FIG. 1 is a drawing of a bag 100 according to an embodiment of the invention. The material from which the bag is formed must be capable of withstanding cooking temperatures up to about 450 degrees Fahrenheit and must exhibit good tear and puncture resistance at temperatures between about 25 degrees Fahrenheit to about 450 degrees Fahrenheit. The bag is preferably formed from a polyamide referred to in the art as nylon 66 (CAS No. 32131-17-2), and is preferably heat stabilized. One of the reasons this material is preferred is that it is less adhesive to meat products than other materials such as other nylons (e.g., nylon 6 or nylon 6/66 copolymer blends). In preferred embodiments, the bag comprises at least 50% nylon 66 by weight, more preferably at least 90% nylon 66 by weight, and more preferably still at least 98% nylon 66 by weight. In highly preferred embodiments, nylon 66 is the sole polymer component of the bag. In still more highly preferred embodiments, the bag preferably consists essentially of the nylon 66 and heat stabilizer. A suitable heat stabilized material is available from Nilit Ltd., located in Israel, under the name “Polynil 66 P-240 HS,” which includes a copper halogen heat stabilizer system. The bag is preferably about 1-2 mils (0.001-0.002 inches) or 100 gage to 200 gage thick and preferably mono-axially oriented, although bags of different thicknesses and orientations (e.g., biaxially orientated or unoriented) are also within the purview of the invention.

The bag 100 has an open end 110 sized to accept the meat product and a sealed end 120. The sealed end 120 is preferably formed with a heat seal 130. However, other types of seals, including, but not limited to mechanical seals (e.g., metal clips or wire ties) are also within the purview of the invention. Regardless of what type of seal is used, it is important that the seal not fail during the cooking process, which is typically performed at temperatures between about 300 degrees Fahrenheit to about 400 degrees Fahrenheit, and more typically between about 325 degrees Fahrenheit to about 375 degrees Fahrenheit. This is because the seal keeps air trapped inside of the bag, which contributes to a gap between the bag and the enclosed meat product during cooking as discussed in further detail below.

The bag is preferably sized such that the bag fits tightly over the meat product to help ensure the meat product does not separate. The tight fit also helps shape the meat product, thereby further contributing to the aesthetic appeal of the product. By way of example and not limitation, the inventors have found that a bag approximately with a width W (as shown in FIG. 1) of approximately 10 inches and a length L of approximately 18.5 inches works well with a turkey breast roast having a weight of about 8-11 pounds and having a generally oval or egg shape. Preferably, the end 120 of the bag also includes chamfered corners 121, which helps the bag 100 fit snugly around a meat product with such a shape. The invention is believed to be particularly well suited for turkey breasts, but is also usable with other meat products including chicken breasts and beef roasts. In preferred embodiments, the bag is imprinted with labels and cooking directions. In such embodiments, no additional exterior packaging is used on individual products (multiple products, e.g. 2, may be shipped in a box).

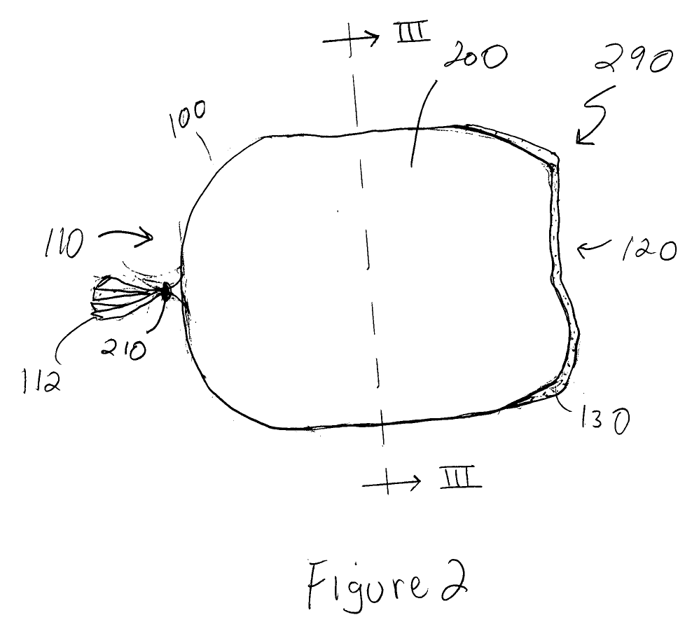

Use of the bag for packaging and cooking of a meat product will now be described. The first step in the process is to place the meat product (which may be, but is not necessarily, marinated) inside of the bag 100. Next, the open end 110 of the bag 100 is preferably gathered such that the bag is as tight as possible around the meat product. Then a conventional metal or plastic wire or clip 210 is placed around the gathered end 110 to hold the end 110 closed, with a portion of the bag 100, which shall be referred to herein as the tail 112, extending beyond the clip 210, resulting in the packaged product 290 of FIG. 2. Other methods for closing the end 110 are possible; however, as with the end 120, it is important that whatever method is used to secure the end 110 is sufficient for the end 110 to remain closed during the cooking process.

The packaged product 290 is then rinsed with hot water at a temperature of about 150 degrees Fahrenheit to rinse debris off the bag 100. The bag 100 absorbs some of the water during this process, which decreases the amount of juices from the meat product 200 absorbed by the bag 100.

After the bag 100 has been rinsed, the tail 112 is twisted as tightly as possible such that the bag 110 is drawn tight around the meat product 200. The hot water from the rinsing step softens the bag, thereby making it easier for factory personnel to handle and twist the tail 112 and allowing the bag 100 to fit more tightly around the meat product 200. This enhances the aesthetics of the packaged product 290. Additionally, twisting the end 110 of the bag helps shape the meat product 200 (the meat product 200 tends to flatten, and twisting the end 110 tightly tends to make the meat product 200 more round), thereby further enhancing the aesthetic appeal of the packaged product 290. The packaged product 290 is then placed in a box or other shipping container such that the tail 112 is under the meat product 200 so that the tail 112 does not unravel. The packaged product 290 is then frozen. Alternatively, the packaged product 290 may be placed directly in a freezer with the tail 112 tucked underneath.

It should be noted that freezing the meat product with the tail 112 of the bag 100 twisted tightly to shape the meat product 200 in the fashion discussed above results in the meat product 200 tending to maintain its shape even if the tail 112 is later untwisted.

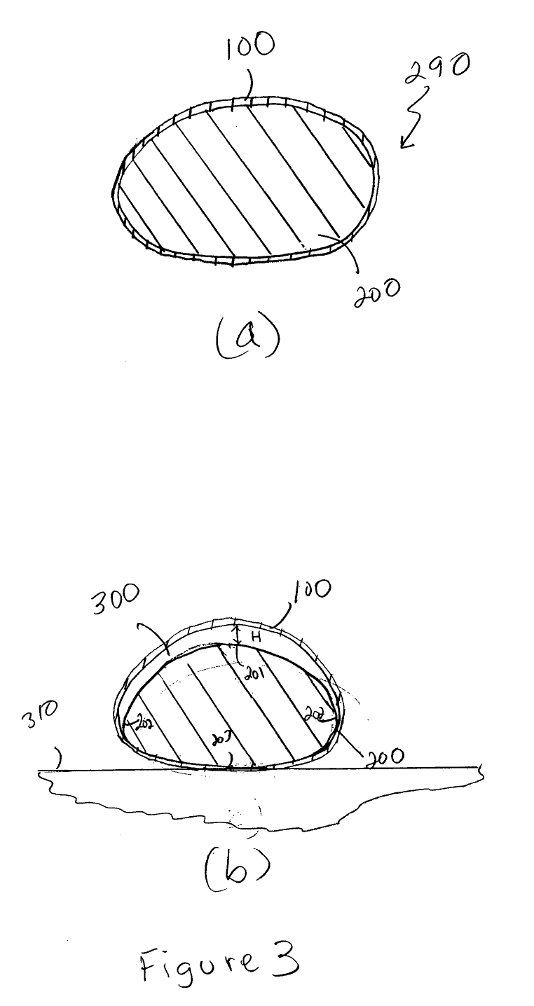

FIG. 3a is a cross sectional view of the packaged product 290 taken along the line III-III of FIG. 2. Note that there is no, or very little, gap between the bag 100 and the meat product 200.

It should also be noted that the 150 degree temperature at which the rinse is performed is much lower than the 190 degree or higher temperature used to activate heat shrink in other prior art bags. Using water at a lower temperature in the rinse process reduces costs. Also, the bags of the present invention preferably do not include any heat shrink additives, which also helps to reduce costs.

The packaged product 290 is then shipped to the end user in frozen form. The end user has the option of defrosting the packaged product 290 before cooking or beginning the cooking process with the packaged product 290 still frozen. As discussed above, the packaged product is cooked at temperatures generally below about 400 degrees Fahrenheit, and usually between about 325 to about 350 degrees Fahrenheit.

During cooking it is preferable for a gap 300 to form between the meat product 200 and the bag 100 as shown in FIG. 3b. The gap 300 serves several purposes. First, it promotes browning of the meat product 200. Second, it facilitates removing the meat product 200 from the bag 100 without removing skin (if the meat product 200 is so provided) and/or other coatings or coverings from the meat product 200. Third, the gap 300 decreases the time required to cook the meat product 200, which reduces costs and adds convenience.

Several factors contribute to the gap 300. First, the bag 100 tends to expand due to the heat associated with the cooking process. Second, the meat product 200 tends to shrink as compared to its frozen form. Third, air in the meat and air trapped between the bag 110 and the meat product 200 expands when heated, which further causes the bag 110 to expand. Fourth, the tail 210, even if placed under the meat product 200 prior to cooking without clipping, sealing or using an enclosure of some kind, tends to untwist during the cooking process, which contributes to the gap 300.

As shown in FIG. 3b, the gap 300 is irregular—it is generally at its highest at the top 201 of the meat product 200, generally decreases along the sides 202 of the meat product 200 until the gap disappears entirely where the bottom 203 of meat product 200 rests on a support surface 310. The gap 300 preferably has a height H of about one inch to about three inches at the top 201, although smaller and larger gaps are also within the purview of the invention (meat products can exhibit some irregularities and the gap may vary accordingly). The use of nylon 66 is particularly advantageous because it does not stretch as much as other nylons (e.g., nylon 6), which helps maintain the desired gap.

Preferably, the clip (or wire) 210 is left on the bag 100 during the cooking process. However, it is also possible to remove the clip 210 and keep the end 110 twisted and tucked under the meat product during cooking without any fastener.

It should also be noted that the seals used for the ends 110, 120 (i.e., the clip 210 and the heat seal 130, respectively) do not allow air inside the gap 300 to vent during the cooking process. In addition to keeping the bag 100 off of the meat product 200 during cooking, this prevents juices from the meat product 200 from leaving the bag 100 during the cooking process, thereby preventing messes. This makes the packaged product 290 both more convenient and less costly. Keeping juices in the bag 100 during the cooking process also makes the meat product 200 more flavorful and juicy.

As discussed above, a significant difference between the bag of the present invention and prior art bags is that the bags of the present invention do not have any added layer, or any material added to the single layer from which the bag is formed, that promotes adhesion of the bag 100 to the meat product 200. This is an important difference between the present invention and the prior art cited above.

A bag suitable for both packaging and cooking of a meat product has been discussed above. The invention provides several benefits, including decreased cooking time, increased durability (especially at low temperatures), and decreased cost, have been discussed. Obviously, numerous modifications and variations of the present invention are possible in light of the above teachings. It is therefore to be understood that within the scope of the appended claims, the invention may be practiced otherwise than as specifically described herein.

1-12. (canceled)

13. A product comprising:
a meat product; and
a bag surrounding the meat product, the bag being a single layer bag comprising nylon 66 in an amount of at least 90% by weight, the bag having a size such that when the bag and meat product are heated to temperatures between about 300 degrees Fahrenheit and about 450 degrees Fahrenheit, an upper portion of the meat product and the bag define a gap, the bag having an end with a seal that remains sealed when the bag and meat product are exposed to temperatures between about 300 degrees Fahrenheit and about 450 degrees Fahrenheit.

14. The product of claim 13, wherein nylon 66 is the sole polymer component of the bag.

15. The product of claim 13, wherein the single layer further comprises a heat stabilizer.

16. (canceled)

17. (canceled)

18. The product of claim 13, wherein the single layer comprises at least 98% by weight of nylon 66.

19. The product of claim 13, wherein the single layer consists essentially of nylon 66 and a heat stabilizer.

20. The product of claim 13, wherein the bag includes an end having chamfered corners.

21. The product of claim 13, wherein the meat product is a red meat product.

22. The product of claim 13, wherein the meat product is poultry.

23. The product of claim 13, wherein the meat product is turkey.

24. The product of claim 13, wherein the meat product includes skin.

25. The product of claim 13, wherein the meat product is marinated.

26. The product of claim 13, wherein the seal is a heat seal.

27. The product of claim 13, wherein the product is free from any individual packaging surrounding the product other than the bag.

28. The product of claim 13, wherein the bag has a thickness of approximately one mil.

29-31. (canceled)

32. The product of claim 13, wherein the bag has a thickness of between approximately one mil and approximately two mils.

33. The product of claim 13, wherein size of the gap is between about one and about three inches.

34. The product of claim 13, wherein the bag bears directions to cook the meat product at a temperature between about 300 degrees Fahrenheit and about 450 degrees.

35. The product of claim 13, wherein the bag has a second end and the product further comprises a metal clip for sealing the second end.

36. The product of claim 13, wherein the bag is mono-axially oriented.

37. The product of claim 13, wherein the bag is free of heat shrink material.

38. The product of claim 13, wherein the bag is free of meat adhesion material.

39. A product comprising:
a meat product; and
a package comprising a bag surrounding the meat product and an outer container in which the bag is placed, the bag comprising nylon 66 and having a size such that when the bag and meat product are heated to temperatures between about 300 degrees Fahrenheit and about 450 degrees Fahrenheit, an upper portion of the meat product and the bag define a gap, wherein the bag has an end with a seal that remains sealed when the bag and meat product are exposed to temperatures between about 300 degrees Fahrenheit and about 450 degrees Fahrenheit and wherein the package bears directions to cook the meat product at a temperature between about 300 degrees Fahrenheit and about 450 degrees Fahrenheit.

40. The product of claim 39, wherein nylon 66 is the sole polymer component of the bag.

41. The product of claim 39, wherein the single layer further comprises a heat stabilizer.

42. The product of claim 39, wherein the single layer comprises at least 50% by weight nylon 66.

43. The product of claim 39, wherein the single layer comprises at least 90% by weight nylon 66.

44. The product of claim 39, wherein the single layer comprises at least 98% by weight of nylon 66.

45. The product of claim 39, wherein the single layer consists essentially of nylon 66 and a heat stabilizer.

46. The product of claim 39, wherein the bag includes an end having chamfered corners.

47. The product of claim 39, wherein the meat product is a red meat product.

48. The product of claim 39, wherein the meat product is poultry.

49. The product of claim 39, wherein the meat product is turkey.

50. The product of claim 39, wherein the meat product includes skin.

51. The product of claim 39, wherein the meat product is marinated.

52. The product of claim 39, wherein the seal is a heat seal.

53. The product of claim 39, wherein the product is free from any individual packaging surrounding the product other than the bag.

54. The product of claim 39, wherein the bag has a thickness of approximately one mil.

55. The product of claim 39, wherein the bag has a thickness of between approximately one mil and approximately two mils.

56. The product of claim 39, wherein size of the gap is between about one and about three inches.

57. The product of claim 39, wherein the bag bears the directions to cook the meat product at a temperature between about 300 degrees Fahrenheit and about 450 degrees.

58. The product of claim 39, wherein the bag has a second end and the product further comprises a metal clip for sealing the second end.

59. The product of claim 39, Wherein the bag is mono-axially oriented.

60. The product of claim 39, wherein the bag is free of heat shrink material.

61. The product of claim 39, wherein the bag is free of meat adhesion material.

62. The product of claim 39, wherein the outer container comprises a box.

63. The product of claim 39, wherein a plurality of the bags, each containing a meat product, is disposed in a single outer container.

64. A product comprising:
a poultry product; and
a bag surrounding the poultry product, the bag being a single layer bag comprising nylon 66 In an amount of at least 90% by weight, the bag having a size such that when the bag and poultry product are heated to temperatures between about 300 degrees Fahrenheit and about 450 degrees Fahrenheit, an upper portion of the poultry product and the bag define a gap of about one and about three inches, the bag having a first end with a heat seal that remains sealed when the bag and poultry product are exposed to temperatures between about 300 degrees Fahrenheit and about 450 degrees Fahrenheit, wherein the first end has chamfered corners and a second end of the bag is sealed with a metal clip, and the bag has a thickness of between approximately one mil and approximately two mils.

65. A product comprising:
a poultry product; and
a package comprising a bag surrounding the poultry product and an outer container in which the bag is placed, the bag comprising nylon 66 in an amount of at least 50% by weight and having a size such that when the bag and poultry product are heated to temperatures between about 300 degrees Fahrenheit and about 450 degrees Fahrenheit, an upper portion of the poultry product and the bag define a gap, wherein the bag has a first end with a heat seal that remains sealed when the bag and poultry product are exposed to temperatures between about 300 degrees Fahrenheit and about 450 degrees Fahrenheit and a second end of the bag which is sealed with a metal clip, wherein the package bears directions to cook the meat product at a temperature between about 300 degrees Fahrenheit and about 450 degrees Fahrenheit.

66. The product of claim 65, wherein the single layer comprises at least 90% by weight nylon 66.

67. The product of claim 65, wherein the poultry product is turkey.
